(19) United States
(12) Patent Application Publication
(10) Pub. No.: US 2025/0141690 A1
(43) Pub. Date: May 1, 2025

(54) ARCHITECTURE CONFIGURED FOR PROVIDING A COMPRESSION FUNCTION FROM WITHIN A HASH FUNCTION

(71) Applicant: SECURE-IC SAS, Cesson-Sévigné (FR)

(72) Inventors: Sylvain GUILLEY, Paris (FR); Sofiane TAKARABT, Arcueil (FR)

(21) Appl. No.: 18/924,841

(22) Filed: Oct. 23, 2024

(30) Foreign Application Priority Data
Oct. 27, 2023 (EP) 23306876.6

(51) Int. Cl. H04L 9/32

(52) U.S. Cl. CPC H04L 9/3239

(57) ABSTRACT

An architecture configured for providing a compression function from within a hash function, including a message input, configured for receiving a message block from a set of message blocks; a hash output, configured for outputting a final state which represents the hash value of the set of message blocks; a compression block for processing blocks of data from the set of message blocks and gradually condensing them into a fixed-size hash value; wherein the architecture is further configured for temporary storing the compressed value between calls of the compression function.

### CROSS-REFERENCE TO RELATED APPLICATION

This application claims priority to foreign European patent application No. EP 23306876.6, filed on Oct. 27, 2023, the disclosure of which is incorporated by reference in its entirety.

### FIELD OF THE INVENTION

The invention is directed to the field of cryptography and secure communications. It relates to an architecture configured for providing a compression function from within a hash function, and also to a method for providing a compression function from within a hash function.

### BACKGROUND

Hash functions are used for data integrity verification, data storage, password storage, and various cryptographic applications. A hash function is a mathematical function that takes an input (or “message”) and returns a fixed-size string of characters. The output (“hash value”) is unique to the input data, and even a small change in the input produces a significantly different hash value.

The advent of the quantum computer has changed the odds in asymmetric cryptography. Indeed, a quantum computer can defeat today's classical cryptographic algorithms, namely RSA and elliptic curve based cryptography (ECC). This applies to all constructs of functions (which includes hash functions), namely key exchange, asymmetric encryption and digital signature.

Therefore, there is a strong push to develop quantum resistant algorithms that would substitute those algorithms. The generic term to designate quantum resistant algorithms is “Post Quantum Cryptography” (PQC). It is possible to specify digital signatures based on hash functions. Those are referred to as HPQC (Hash-based Post-Quantum Cryptography).

However, one of the reasons for the inefficiency of HPQC is that hash primitive functions (e.g. SHA2, cf[SHA2]) operate under a rigid mode of operation, made to hash very large amount of data, in a stereotyped manner.

Namely, the classical mode of operation consists in:
initialize: prepare the hash function to accept forthcoming data to be hashed;
update: submit consecutively blocks of data to be hashed; this operation can be halted in the middle and subsequently resumed-only knowledge of an intermediate state, referred to as “context” is required to pursue the computation;
finalize: end the computation and deliver the result.

This way of operating the hash function comes with an overhead, namely a mandatory prelude (resp. postlude) function to prepare the hash function (initialize, resp. finalize), which does not provide conciseness in the hash computation. Paper [LMS_23] discloses a corresponding hardware implementation. However, this way of operating data turns out to be efficient only in the long run, when the message consists in multiple data blocks to hash, as the prelude/postlude are amortized.

Besides, in the context of safety, a device must be able to reboot while it is in mission. For example, a chip part of an automotive car driving on the road must have the ability to re-establish its functionalities in a very short amount of time in case of any hazard. The “1 ms” constraint is very hard to reach by a naïve implementation of HPQC[AFRICACRYPT20] (see last column of Table 4, where all numbers are >1 million clock cycle, i.e., >1 ms assuming already a favorable case of a 1 GHz clock frequency), because the evaluation of hash functions is long.

Therefore, there is a need for providing an architecture which overcomes the aforementioned problems.

### SUMMARY OF THE INVENTION

An object of the present invention is an architecture and a method according to the appended claims.

### BRIEF DESCRIPTION OF THE DRAWINGS

Additional features and advantages of the present invention will become apparent from the subsequent description, taken in conjunction with the accompanying drawings:

FIG. 1 illustrates a mode of chaining when processing a message which is longer than one block.

FIG. 2a illustrates a first embodiment of an architecture according to the invention.

FIG. 2b illustrates a second embodiment of an architecture according to the invention.

FIG. 3 illustrates an example of Boolean mixing function unit.

FIG. 4 illustrates an example of implementation of the invented architecture.

### DETAILED DESCRIPTION

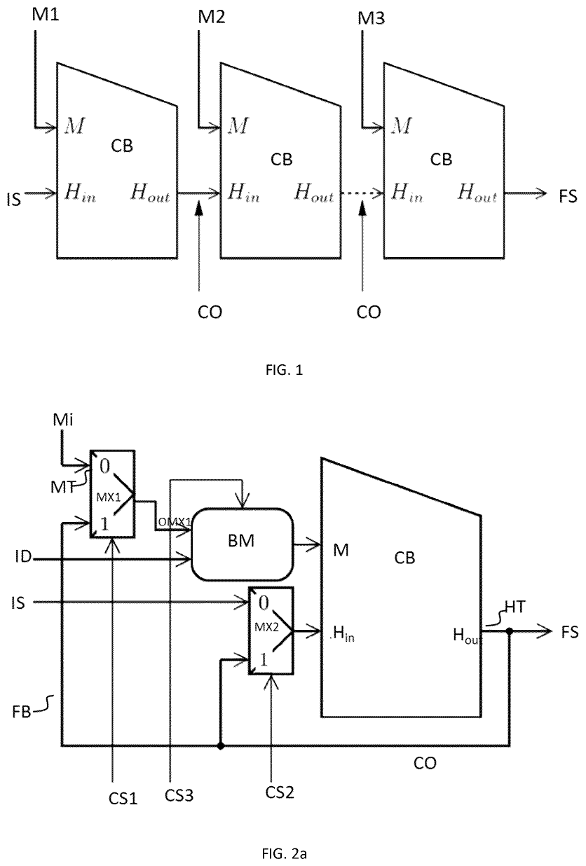

FIG. 1 illustrates a mode of operation based on chaining, which is implemented when the messages are too long to be taken as an input of the hash function.

The compression function typically starts with an initial state IS, which is called the “chaining value.” This initial state IS is set to a predefined constant. Each message block (M1, M2, . . . , Mn) is processed by a compression block CB, and the compression function incorporates this block into the current state.

Once all message blocks have been processed, the final state FS represents the hash value. This state is formatted as a fixed-length sequence to produce the hash output.

A state, also referred to as intra-hash context (abridged simply as “context” when there is no ambiguity), is maintained. It allows to interrupt a computation in case data is starving (processing of the hash is therefore slowed down owing to the absence of data to hash). or another hash function shall be executed with higher priority (context CO is subsequently stored so that, after preemption, it can be restored).

Eventually, plaintext is padded. Padding values (which do not depend on manipulated data) can be injected via the input of the message blocks (M1, M2, . . . , Mn). In particular, it allows inserting information about the message size, to avoid prefix attacks. Padding allows accommodating message of (almost) arbitrary size (namely: L<264). However, padding incurs a performance loss for small messages. For instance, in SHA2, when the message size L is less than the block size (512), and of length L≥512−64=448, then instead of hashing only one block, at least two blocks shall be hashed, which is definitely sub-optimal (a factor two in performance is lost).

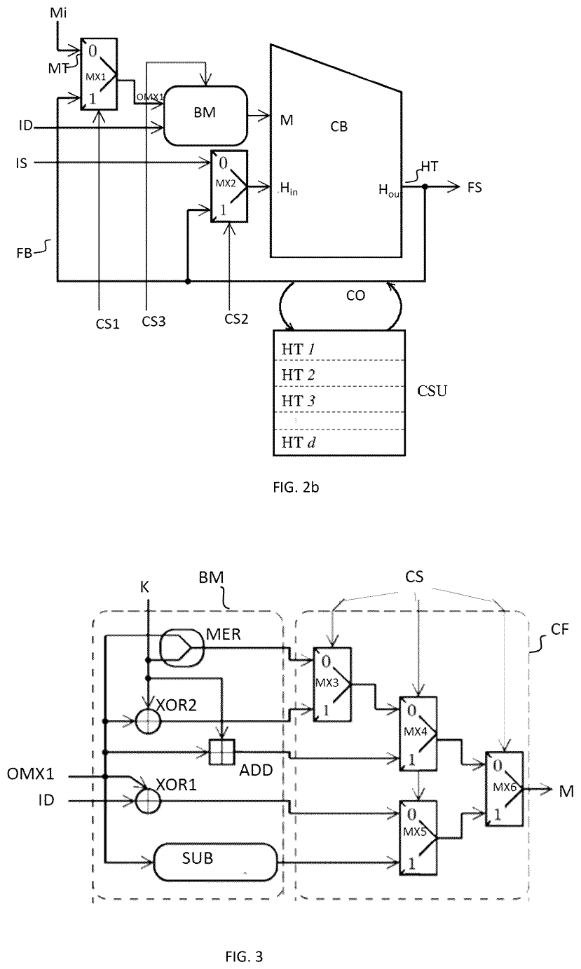

FIG. 2a illustrates the invented architecture configured for providing a compression function from within a hash function. The architecture comprises a message input MT which receives a message block Mi from a set of message blocks (M1, . . . , Mn), a hash output HT which outputs a final state FS which represents the hash value of the set of message blocks (M1, . . . , Mn). A compression block CB processes each block of data Mi from the set of message blocks (M1, . . . , Mn) and gradually condenses them into a fixed-size hash value. The architecture temporary stores the compressed value between calls of the compression function. The call of hash functions is a feature that is intrinsic to the HPQC algorithms (which implement hash-trees); thus the invention is well-suited for HPQC algorithms.

Super-hashing, that is hashing a hash output, is not natural since hash functions outputs already consist in multiple iterations of a compression functions; it is even less intuitive when considering repeated re-application of the hash function (composition of multiple hash functions repeatedly).

Composition is all the more artificial as the sizes do not match (the input is larger than the output). For instance, SHA-256 (resp. SHA-224) take 512 bits as input, and output a digest of 256 bits (resp. 224 bits), or also SHA-512 (resp. SHA-384) take 1024 bits as input and output a digest of 512 bits (resp. 384 bits).

A local memorization resource enables temporary storing hash results so as to avoid lengthy data transfers, back and forth from a memory. The addition of a data context, for temporary storing the compressed value between calls of the compression function, can be materialized by adding internal state registers. The size of the registers can be adapted for the used primitive such as SHA2, SHA3, Haraka, ASCON ([ASCON]), or Quark ([QUARK_10]).

A feedback path FB is connected to the compression function output HT, in order to mix the function output HT with the message input MT. Thus, the direct path from hash output to text input allows for legacy multi-block hashing (feedback from Hout to Hin), but also for iterated hashing.

The memorization is ensured with the combinational loop CO in the FIG. 2a.

But, alternatively, it can be implemented explicitly by the instantiation of a Context Saving Unit CSU.

This unit is optional and is shown in FIG. 2b.

This unit can have a depth of 1, 2, or more. d is considered as its depth in general.

Then, the case with d=0 (no Context Saving Unit CSU) coincides with the embodiment shown in FIG. 2a.

The case with d=1 is that allowing for a suspension/interruption of only one computation, with the possibility to resume anytime by restoring the cached hash results HT with saved HT1.

The cases with d>1 correspond to multiple nested interruptions. Resuming can be done by unstacking the contexts (the Context Saving Unit CSU is then a FIFO=First-In-First-Out queue) or in selecting which computation to resume, based for instance on a notion of quality of service (QOS).

In any case, it can be noticed that a feedback through an external path (connection outside of the hash block, from the output intermediate hash value Hout to the input M in the compression block CB) would be too slow. Indeed, the final state FS and the message block Mi are typically connected to data buses, that induce latency and require a data serialization (hash values are 256-bit long at least with SHA2-256), whereas buses carry usually double words (i.e. words of 32 bits). The serialization consists in cutting the 256-bit word into 8 double words, to be submitted sequentially on the bus.

Advantageously, the cached hash results (HT1, HT2, . . . ) can be inter-hash contexts.

This is the case when the storage is performed at the end of a hash function (after all the iterations making up the hash function computation are finished).

This means that the values of the cached hash results HT are not those occurring amidst the iterations of a the hash function (referred to as “intra-hash” contexts, in this invention), but the final values of the hash function, which occur between consecutive calls of the hash function (referred to as “inter-hash” contexts, in the invention).

In this case, what is stored in the Context Saving Unit CSU unit are intermediate hashes (“output of hash functions”).

This mechanism is of special interest in HPQC as those algorithms are slow (they typically require hundreds to several thousand calls to the hash function).

By allowing them to be interrupted, it ensured that they do not block the system in case of an important HPQC operation request shall unexpectedly be served with higher priority.

Besides, the insertion of a direct path from hash primitive output to hash primitive text input allows on-the-fly chaining of hashes. In this respect, keeping hash values local at the compression block CB provides a decisive advantage in terms of performance. Indeed, hash values are large (e.g., 256, 384 or 512 for the SHA2 hash function variants), hence copying these data back and forth takes a lot of time, which can be saved by implementing the shortcut of the feedback path FB directly connecting the output intermediate hash value Hout to the message input MT of the compression block CB.

The architecture advantageously comprises a first multiplexor MX1 which takes as an input the feedback path FB and the message input MT. The first multiplexor MX1 selects the input of the chaining mode (feedback path FB or message input MT), based on a first control signal CS1. It is reminded that a multiplexor is an component which allows selecting one value out of several ones (two or more), based on a control signal. It can be implemented in hardware as a logic gate within the datapath in such a way to choose the adequate input within the same clock period, thereby not loosing clock cycles to make the decision. It allows saving the time to store and copy selected data, as it simply flows through the multiplexor.

The output OMX1 of the first multiplexor MX1 is connected to the input of a Boolean mixing function unit BM, which applies at least one Boolean function between the output OMX1 of the first multiplexor MX1 and internal data ID which are used in the compression function. The Boolean mixing function unit BM is connected to the input port of the compression block CB which is dedicated to the message block M=(m₀, m₁, . . . , m₆₃). The output of the Boolean mixing function unit BM depends on a third control signal CS3.

A second multiplexor MX2 takes as an input the feedback path FB and an initial state IS of the compression function. Based on a second control signal CS2, it selects one of the input signals, as an input intermediate hash value (Hin) of the compression block CB. The output intermediate hash value (Hout) is provided at the function output HT.

Therefore, the first multiplexor MX1 and the second multiplexor MX2 allow different paths depending for instance on the supported HPQC algorithms (XMSS[IETF RFC 8391], LMS [IETF RFC 8554], Sphincs+ or SLH-DSA[FIPS 205], etc.), and their sub-function (HPQC protocol key generation, signature generation or signature verification).

FIG. 3 illustrates an example of implementation of the Boolean mixing function unit BM. The inputs are the output of the first multiplexor OMX1 and to the internal data ID.

The Boolean mixing function unit BM may comprise at least one XOR. A first XOR (XOR1) may take as an input the output of the first multiplexor OMX1 and the internal data ID. It corresponds to an exclusive OR between both data, i.e. it produces a true output (1) when the inputs are different and a false output (0) when the inputs are the same. A second XOR (XOR2) may take as an input the output of the first multiplexor OMX1 and a constant value K, so as to add that constant value to the output of the first multiplexor OMX1, e.g. by using a bitwise XOR.

The Boolean mixing function unit BM may also comprise an arithmetic addition. For that, an addition operator ADD takes as an input the output of the first multiplexor OMX1 and the constant value K. Thus, an integer addition in a modulo ring (i.e. a modular addition) is implemented.

The Boolean mixing function unit BM may also comprise at least one “merge” unit MER. The merge unit MER concatenates the output of the first multiplexor OMX1 and the constant value K (collation of two busses, also denoted “∥” in IETF RFC 8554).

Still in another embodiment, Boolean function unit BM comprises at least one “subrange” unit SUB, which selects of a part of the output of the first multiplexor OMX1. For example, a slice of bits of the feedback path FB may be extracted by the subrange unit SUB.

All the outputs of the Boolean mixing function unit BM may be connected to a multiplexing tree CF, which comprises:
a third multiplexor MX3 which is connected to the merge unit MER and to the second XOR (XOR2);
a fourth multiplexor MX4 which is connected to the output of the third multiplexor MX3 and to the output of the addition operator ADD;
a fifth multiplexor MX5 which is connected to the output of the first XOR (XOR1) and to the output of the subrange unit SUB;
a sixth multiplexor MX6 which is connected to the output of the fourth multiplexor MX4 and fifth multiplexor MX5.

Therefore, the multiplexing tree CF selectively activates one of the inputs of each multiplexor, based on external control signals CS which are timely delivered. The Boolean mixing function unit BM, which is coupled to the multiplexing tree CF, enables on-the-fly tweaking of the hash block, which avoids any disruption of the hash function and which also reduces the computing time. Besides, the size of the source code is reduced, since fewer operations are done by the processor.

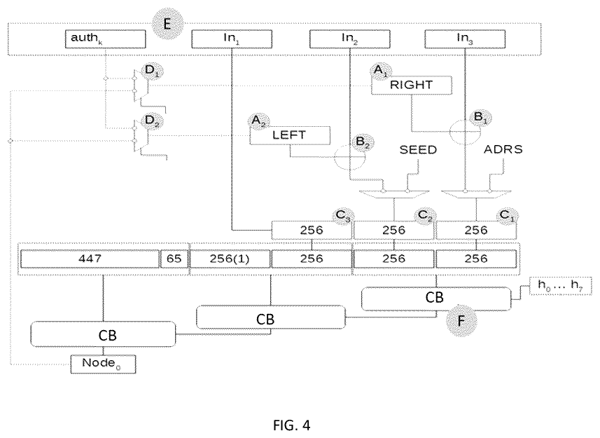

FIG. 4 illustrates an example of implementation of the invented architecture, in a dataflow style, which is particularly adapted for XMSS (Extended MerkleSignature Scheme, which is a type of hash-based cryptography). The four 256-bit inputs (In₁, In₂, In₃ and authₖ) allow for implementing the “Randomized Tree Hashing” (called RAND_HASH, in the XMSS specification, detailed in Alg. 7 of § 4.1.4 of [IETF RFC 8391]). Input In₁ accommodates parameter KEY, input In₂ accommodates BM_0 and input In₃ accommodates BM_1. The authₖ input accommodates the data auth[k] defined for instance in § 4.1.8 of the aforementioned XMSS standard. The output node₀ is an intermediate value on a node of the tree of hashes being computed. FIG. 4 takes into account SHA-256 as the hash primitive. For the sake of pedagogy, multiple SHA compression blocks CB are displayed. In practice, it could be the same that is reused multiple times, as shown in FIG. 2. The initial state IS comprises standard initial values (h₀, . . . , h₇) of SHA2 hash function.

The addition of a (data) context is materialized by internal state registers (C1, C2 and C3) of 256 bits. Context registers (A1, A2) of the HPQC algorithm are delegated to upper level. They contain either the right (RIGHT) and left (LEFT) halves of the former computation (value node₀), or the external authₖ value. This selection is determined by the control of XMSS algorithm, implemented as D1 and D2 multiplexors. The Boolean functions of the Boolean mixing function unit BM are embodied by Boolean operators (B1 and B2). Thus, the definition of extra modes of operations that are needed in addition to the basic ones (namely: initialize/update/finalize), including the Boolean mixing function unit in the feedback loop, is substantiated by tactics of context registers (A1, A2) and Boolean operators (B1 and B2).

The first multiplexor MX1 selects the input of the chaining mode, by means of multiplexors (D1 and D2) for input selection, which enable a flexibility strategy. The input register E is adapted to the HPQC algorithm. SHA compression blocks CB have state registers configured by multiplexors.

The feedback path FB of FIG. 2, which corresponds to the path from hash output to hash message input, is visible as inputs of the compression blocks CB.

The representation of FIG. 4 illustrates the detail of the exact feedback mode of data, and the exact size of the state registers. Namely, it is shown how many 256-bit registers are needed, and also how many other-size-registers (namely 65 and 447 bits) registers are needed. The register indicated as “256(1)” corresponds to the following constant value (in hexadecimal format) which implements padding:
0x00000000_00000000_00000000_00000000_00000000_00000000_00000000_00000001
SEED and ADRS relate to the corresponding inputs that are standardized in XMSS.

The invention is particularly adapted for integration in a secure-boot device, for firmware integrity, firmware management, or authentication verification. Indeed, it enables a rapid execution of the secure-boot in less than 1 ms. The speed of firmware integrity/authenticity is a mandatory safety-critical applications, such as those complying to IEC 61508 or ISO 26262, which require a fast reboot process in case a hazard is detected. Indeed, the reboot is done in mission mode, and the system can withstand a service interruption of a maximum of one 1 millisecond (example of a car travelling at high speed). The invented architecture uses a local memorization resource, which saves time during the digital signature verification.

### CITED REFERENCES

[SHA2] Secure Hash Algorithm (SHA). FIPS PUB 180-2; NIST/ITL/CSD, November 2001. http://csrc.nist.gov/publications/fips/fips180-2/fips180-2withchangenotice.pdf
[LMS_23] Yifeng Song, Xiao Hu, Jing Tian, Zhongfeng Wang: A High-Speed FPGA-Based Hardware Implementation for Leighton-Micali Signature. IEEE Trans. Circuits Syst. I Regul. Pap. 70 (1): 241-252 (2023)
[AFRICACRYPT20] Fabio Campos, Tim Kohlstadt, Steffen Reith, Marc Stöttinger: LMS vs XMSS: Comparison of Stateful Hash-Based Signature Schemes on ARM Cortex-M4. AFRICACRYPT 2020:258-277
[IETF RFC 8391] A. Huelsing et al., XMSS: extended Merkle Signature Scheme, https://datatracker.ietf.org/doc/html/rfc8391; dated May 2018
[IETF RFC 8554] D. McGrew et al., Leighton-Micali Hash-Based Signatures, https://datatracker.ietf.org/doc/html/rfc8554
[FIPS 205] Stateless Hash-Based Digital Signature Standard (SLH-DSA), by National Institute of Standards and Technology (NIST). Published: Aug. 13, 2024
[QUARK_10] Jean-Philippe Aumasson, Luca Henzen, Willi Meier, and Maria Naya-Plasencia. “Quark: a lightweight hash”, CHES 2010, https://www.iacr.org/archive/ches2010/62250001/62250001.pdf
([ASCON] C. Dobraunig et al. ASCON v1.2, https://csrc.nist.gov/CSRC/media/Projects/lightweight-cryptography/documents/round-2/spec-doc-rnd2/ascon-spec-round2.pdf

1. An architecture configured for providing a compression function from within a hash function, comprising:
a message input (MT), configured for receiving a message block (Mi) from a set of message blocks (M1, . . . , Mn);
a hash output (HT), configured for outputting a final state (FS) which represents the hash value of the set of message blocks (M1, . . . , Mn);
a compression block (CB) for processing blocks of data (Mi) from the set of message blocks (M1, . . . , Mn) and gradually condensing them into a fixed-size hash value;
wherein the architecture is further configured for temporary storing the compressed value between calls of the compression function.

2. The architecture according to claim 1, comprising a feedback path (FB) connected to the compression function output (HT), said feedback path (FB) being configured to be mixed with the message input (MT).

3. The architecture according to claim 1, wherein said temporary storing is implemented by a Context Saving Unit (CSU), which is configured for restoring cached hash results (HT).

4. The architecture according to claim 3, wherein the cached hash results (HT1, HT2, . . . ) correspond to inter-hash contexts.

5. The architecture according to claim 2, comprising a first multiplexor (MX1) which is configured to take as an input the feedback path (FB) and the message input (MT), and a second multiplexor (MX2) which is configured to take as an input the feedback path (FB) and an initial state (IS) of the compression function, said first multiplexor (MX1) and said second multiplexor (MX2) being configured to enable a plurality of modes of operation of the compression function, based on control signals (CS1-CS3).

6. The architecture according to claim 5, comprising a Boolean mixing function unit (BM), which is configured to apply at least one Boolean function between the output (OMX1) of the first multiplexor (MX1) and internal data (ID) which are used in the compression function.

7. The architecture according to claim 6, wherein the Boolean function comprises at least one XOR.

8. The architecture according to claim 6, wherein the Boolean function comprises at least one ADD operator, said ADD operator corresponding to an integer addition in a modulo ring.

9. The architecture according to claim 4, wherein the Boolean function comprises at least one “merge”, wherein “merge” corresponds to a concatenation of two inputs of the Boolean mixing function unit (BM).

10. The architecture according to claim 6, wherein the Boolean function comprises at least one “subrange”, wherein “subrange” corresponds to a selection of a part of the bits of one of said inputs.

11. The architecture according to claim 1, wherein the compression is that from a standard hash function SHA2, SHA3, Haraka, ASCON, or Quark.

12. A secure-boot device, comprising an architecture according to claim 1 for firmware integrity or authentication verification.

13. A method for providing a compression function from within a hash function, comprising:
receiving a message block (Mi) from a set of message blocks (M1, . . . , Mn) at a message input (MT);
outputting, from a hash output (HT), a final state (FS) which represents the hash value of the set of message blocks (M1, . . . , Mn);
processing blocks of data (Mi) from the set of message blocks (M1, . . . , Mn) and gradually condensing them into a fixed-size hash value;
wherein the method further comprises temporary storing the compressed value between calls of the compression function.

14. The method according to claim 13, wherein a feedback path (FB) is mixed with the message input (MT).

15. The method according to claim 14, wherein a first multiplexor (MX1) takes as an input the feedback path (FB) and the message input (MT), and a second multiplexor (MX2) takes as an input the feedback path (FB) and an initial state (IS) of the compression function, said first multiplexor (MX1) and said second multiplexor (MX2) enabling a plurality of modes of operation of the compression function, based on control signals (CS1-CS3).

16. The method according to claim 15, wherein a Boolean mixing function unit (BM) applies at least one Boolean function between the output (OMX1) of the first multiplexor (MX1) and internal data (ID) which are used in the compression function.

17. A computer program product comprising computer-executable instructions to cause a computer system to carry out a method according to claim 13.
